(19) United States
(12) Patent Application Publication
(10) Pub. No.: US 2015/0246377 A1
(43) Pub. Date: Sep. 3, 2015

(54) WASHING MACHING INCLUDING INTEGRAL FILTER MODULE AND AERATOR

(71) Applicant: Dow Global Technologies LLC, Midland, MI (US)

(72) Inventors: Patrick B. He, Huzhou (CN); Chengfeng Wang, Huzhou (CN); Bill Q. Cai, Hangzhou (CN); Tong Sun, Shanghai (CN); Michael P. Gao, Shanghai (CN)

(73) Assignee: Dow Global Technologies LLC, Midland, MI (US)

(21) Appl. No.: 14/422,859

(22) PCT Filed: Sep. 28, 2012
(86) PCT No.: PCT/CN2012/082373

§ 371 Date: Feb. 20, 2015

(51) Int. Cl. B08B 3/14; B01D 61/58; D06F 39/10; C02F 1/44; D06F 39/08; A47L 15/42; B01D 65/02

(52) U.S. Cl. CPC B08B 3/14; A47L 15/4208; A47L 15/4219; B01D 61/58; B01D 65/02; C02F 1/44; D06F 39/083; D06F 39/10; B01D 2321/185; B01D 2319/025; C02F 2103/002

(57) ABSTRACT

A washing machine and a corresponding method for cleaning ware or laundry items are provided. The machine comprises: a wash tub (12), a water inlet (14) and a waste water outlet (16) in fluid communication with the wash tub, a fluid pathway (18) extending from the waste water outlet to the water inlet, a pump (20) for moving water along the fluid pathway, a filter module (22) located along the fluid pathway, and an aerator (24) in fluid communication with the filter module.

### FIELD

The present invention is directed toward washing machines for washing laundry or “ware” items such glassware, tableware, flatware, dishware, cookware and the like.

### INTRODUCTION

Washing machines for cleaning laundry and ware items are well known in the art. A typical washing machine includes a wash tub and an electrically operated pump which are housed in a cabinet. The tub is accessible by way of a sealable door. During a typical wash cycle, water and detergent are combined and manipulated about the wash tub during a washing stage, after which time the resulting waste water is discharged. The tub is subsequently refilled with fresh feed water in one or more rinse stages. The repetitive filling and draining of the wash tub takes time and uses a large quantity of water.

### SUMMARY

In a primary embodiment, the present invention reduces water consumption and refilling time associated with washing laundry and ware items. The invention includes a washing machine comprising the following components:

i) a wash tub,

ii) a water inlet and waste water outlet in fluid communication with the wash tub,

iii) a fluid pathway extending from the waste water outlet to the water inlet,

iv) a pump for moving water along the fluid pathway,

v) a filter module located along the fluid pathway, and

vi) an aerator in fluid communication with the filter module.

In another embodiment, the invention includes a method for cleaning items using such a washing machine, including a wash cycle including multiple stages wherein waste water resulting from a stage passes through the filter module and is reused in the same stage or in a subsequent stage. For example, in one embodiment, the wash cycle comprises a wash stage followed by a first and second rinse stage, and waste water resulting from the first rinse stage is continuously passed through the filter module and reused in the first rinse stage or separately used in the second rinse stage. Debris including one or more of bacteria, viruses, protozoa and surfactants are at least partially removed from the waste water prior to reuse.

### BRIEF DESCRIPTION OF THE DRAWINGS

FIG. 1 is schematic view of an embodiment of a washing machine according to the present invention.

### DETAILED DESCRIPTION

As used herein, the term “ware” refers to items such as glassware (e.g. bottles), tableware, flatware (e.g. cutlery, utensils), dishware (e.g. dishes), cookware, (e.g. pots, pans) and other items for use with food and beverages during their preparation, storage or consumption. The term “laundry” refers to items made from textiles or fabrics including items such as clothing and linens (e.g. tablecloths, bedding, towels, etc.). In one embodiment, the invention includes a washing machine designed to clean ware items. In another embodiment, the invention includes a washing machine designed to clean laundry items.

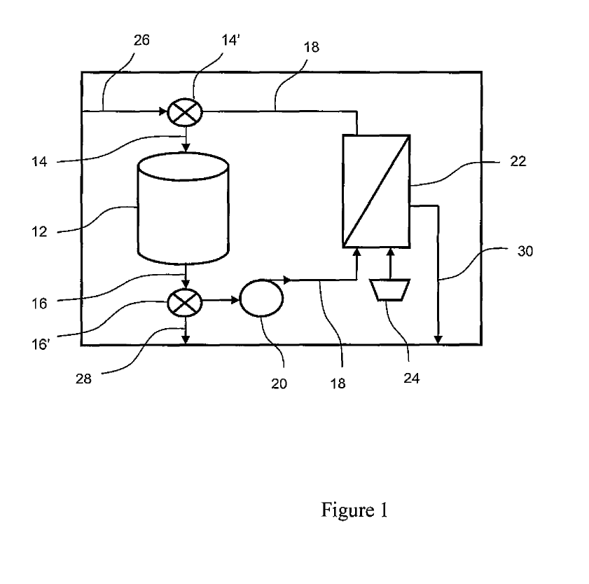

A schematic view of a generic embodiment of the invention is provided in FIG. 1 wherein a washing machine is generally shown at 10 including a wash tub (12) adapted to temporarily house items to be cleaned. While not particularly limited, the wash tub (12) preferably includes a sealable door that provides convenient access to an inner chamber. In an embodiment designed to clean ware items, the wash tub (12) may include shelves and compartments for securing ware items during cleaning. In an embodiment designed to clean laundry, the wash tub (12) may include cylindrical drum which is capable of spinning about an axis. The wash tub (12) is in fluid communication with at least one water inlet (14) and a waste water outlet (16). The water inlet (14) is adapted to provide a route for liquid to flow into the wash tub (12) while the waste water outlet (16) provides a route for waste water to flow out of the tub (12). The inlet (14) and outlet (16) may include or be connected to valves (14′, 16′) that selectively control ingress and egress of liquid into and out of the tub (12). For purposes of this description, the term “waste water” refers to water that has been used to either wash or rinse items within the tub (12). A fluid pathway (18) comprising one or more pipes extends from the waste water outlet (16) to the water inlet (14). A pump (20) provides a driving force for moving water along the fluid pathway (18). As will be described below, one or more pumps may be utilized.

A filter module (22) is located along the fluid pathway (18). While shown as a single unit, multiple filter modules may be used in a parallel of serial arrangement. The filter module (22) may include a wide variety of separation mediums including membrane-based modules (e.g. spiral wound, hollow fiber, capillary, flat disks, and tubular membrane modules or “elements”). Representative semi-permeable membranes include those made from: various ceramics, polysulfones, polyether sulfones, polyvinylidene fluoride, polyamides, polyacrylonitrile, polyolefins, etc. The membranes may be suitable in a wide range of applications including but not limited to microfiltration (MF), ultrafiltration (UF), nanofiltration (NF) and reverse osmosis (RO). In preferred embodiments, the module includes a plurality of semi-permeable membranes located within an inner chamber of a housing. The average pore size of the hollow fiber membranes utilized within the filter module (22) may be selected so as to preferentially remove debris such as food, grease, proteins, oils and the like, e.g. average pore sizes in the microfiltration range (i.e. 0.1 to 5 micron). In a preferred embodiment, the average pore size of the membrane is in ultrafiltration range, (i.e. 0.01 to 0.10 micron) such that protozoa, bacteria and viruses are at least partially removed. It has surprisingly been observed that a substantially amount of surfactants (e.g. example) can additional be removed by ultrafiltration with mean flow pore size less than 0.05 microns. In one embodiment, a plurality of semi-permeable hollow fiber membranes are orientated axially within an inner chamber. The ends of the hollow fibers are sealed from the inner chamber by way of well known “potting” techniques wherein one or both ends of the hollow fibers remain open and in fluid communication one or more outer chambers formed within an end cap assembly. In a preferred embodiment, the filter module (22) comprises a tubular-shaped housing, (e.g. an elongated shell having a length greater than its width), extending along an axis between two opposing ends and defining an inner chamber. The outer periphery of the filter module is cylindrically-shaped having a circular cross-section. The housing may be constructed from a wide variety of materials, e.g. plastics, ceramics, metals, etc., however, in one set of preferred embodiments the housing is made from an injection moldable plastic such as polyvinyl chloride (PVC) or acrylonitrile butadiene styrene (ABS). Representative examples include miniaturized versions of Dow™ UF modules SFX 2660 and SFX 2680.

The washing machine (10) further includes an aerator (24) in fluid communication with the filter module (22). The aerator provides a source of gas bubbles (e.g. air bubbles) to the inner chamber of the filter module which remove debris from the surface of membrane. In one embodiment, the aerator comprises one or more gas nozzles in fluid communication with a source of gas such as ambient air. Gas pressure may be generated by an independent pump or gas blower (not shown). Alternatively, gas bubbles may be generated using the same pump (20) used to move water along the fluid path (18). For example, the aerator (24) may include a valve positioned along the fluid pathway (18) which selectively opens to permit air to be drawn into the fluid pathway as water passes through the pathway, i.e. via a Venturi effect. While not shown, the aerator may also be in direct fluid communication with the wash tub (12) to provide gas bubbles to the tub during cleaning or rinse stages.

The washing machine includes a feed water port (26) adapted for connection to a source of water (e.g. tap water), a waste discharge port (28) adapted for connection with an external drain, and a filter discharge port (30) adapted to an external drain. The waste discharge port (28) and filter discharge port (30) may be combined into a single port. Each port may include a valve which may be selectively opened or closed during operation.

In a preferred embodiment the aforementioned components of washing machine (10) are integrally housed within a cabinet (32). In a preferred commercial embodiment, the filter module (22) is relatively small in size as compared with the washing machine, e.g. the volume ratio of the filter module (22) to the cabinet (32) is preferably from 1:20 to 1:1000.

The preferred method of cleaning includes a wash cycle comprising at least one wash stage followed by at least one and preferably two rinse stages. The method is characterized by at least one stage reusing water from a preceding stage that has passed through the filter module (22). Wash stages are characterized by the combination of water with a detergent or other cleaning composition whereas rinse stages generally include no detergent (although anti-scalants may be used). That is, in a preferred embodiment, the wash cycle comprises at least one wash stage comprising the introduction of water and a detergent into the wash tub followed by at least one rinse stage wherein waste water which has passed through the filter module is reintroduced into the wash tub without adding detergent.

In operation, items to be cleaned are positioned within the wash tub (12) and feed water selectively enters the wash tub (12) by way the feed water port (26). Automated valves and a pump may facilitate this process so that an optimized water level is achieved. Detergent or other cleaning compounds also may also be provided and the resulting wash water is sprayed, agitated or otherwise manipulated about the tub (12) to remove debris from the items. Thereafter, i.e. typically 10 to 30 minutes, the wash stage ends and the resulting waste water is drained from the tub (12) by way of the waste water outlet (16). Once again, automated valves and the pump (20) may facilitate this process. The waste water may be removed from the washing machine (10) by opening waste discharge port (28), or the waste water (or portion thereof) may be recycled by passing through the filter module (22).

After the wash stage one or more rinse stages are initiated. Water comprising feed water from the feed water port (26) or permeate passing through the membrane of the filter module (22), or a combination of both water sources is used as rinse water and is introduced into the wash tub (12) through water inlet (14). A preferred mix ratio is at least 3:1 permeate to fresh feed water. When operated in cross-flow mode, concentrated waste water unable to pass through the membranes may be discharged by way of the filter discharge port (30). When operating in dead end flow mode, debris is collected within the module (22), which may be replaced on a periodic basis. In a preferred embodiment, waste water from the wash stage is disposed of via the waste discharge port (28), but waste water from the first rinse stage is recycled through the filter module (22) and reused.

The membrane is cleaned by introducing gas bubbles into the filter module (22) by way of the aerator (24). Bubbles flow upward through the module (22) and dislodge debris that collects upon the surface of the membrane. The bubbles may then selectively exit the module (22) by way of filter discharge port (30). Additionally, feed water may be periodically back-flushed through the membrane and removed from the module (22) by way of the filter discharge port (30). Aeration may be conducted after a wash or rinse stage, or may be continuous throughout one or more stages. Similarly, filtration of waste water may occur continuously through a wash or rinse stages, or be conducted off-line and stored within an interior or exterior holding tank for use in subsequent wash or rinse stage. In a preferred embodiment, filtration occurs continuously during the first rinse stage. Integrated circuitry or similar means may be used to control stage timing and value actuation during the cycle.

In addition to wash and rinse stages, integrated circuitry may be suitable to implement a separate cleaning stage. In this cleaning stage, aeration may be performed without permeation through the module (22). Alternatively, the cleaning stage may also include aeration and backwash (reverse permeation from normal operation) and/or forward wash from through the module (22). For instance, this may be implemented by redirecting a valve to provide pressurized water from the feed water port (26), the wash tub (12) or pump (20) to the module's inner chamber. This cleaning stage may include continuous or batch removal of debris from the module (22) through the discharge port (30). The cycle time for the cleaning stage may be longer than for either the wash or rinse stages.

Following are non-limited examples of this invention. It should be understood that the reduced total water consumption calculated in the examples depend on the water consumption during the stages, and should not be treated as limitation of the invention.

### EXAMPLES

### Example 1

A washing machine (8 kg wash tub capacity) as configured in FIG. 1 may be operated with a wash stage followed by two sequential rinse stages with each stage utilizing approximately 20 liters of water. Waste water associated with the wash stage is discharged via the water discharge port. Waste water associated with the first rinse stage is continuously filtered through a filtration module (UF hollow fiber) operating in dead-end mode. The resulting permeate is combined with fresh feed water and reused for the second rinse stage. A preferred mix ratio is at least 3:1 permeate to fresh feed water. Aeration of the filter module is preferably conducted during the rinse stage. This embodiment of the invention reduces total water consumption by approximately ⅓ per cycle and further reduces the total time of the cycle. The filter module (22) removes debris, bacteria and viruses from the waste water so that the items in the wash tub (12) do not become soiled or contaminated.

### Example 2

A washing machine (8 kg wash tub capacity) as configured in FIG. 1 may be operated with a wash stage followed by a sequential rinse stage utilizing approximately 20 liters of water. Waste water associated with the wash stage is discharged via the water discharge port. Waste water associated with the first rinse stage is continuously filtered through a filtration module (UF hollow fiber) operating in dead-end mode. The resulting permeate is reused for the rinse stage. Aeration of the filter module is preferably conducted during the rinse stage. This embodiment of the invention reduces total water consumption by approximately ⅓ per cycle and further reduces the total time of the cycle. The filter module (22) removes debris, bacteria and viruses from the waste water so that the items in the wash tub (12) do not become soiled or contaminated.

1-10. (canceled)

11. A washing machine comprising the following components which are housed within a cabinet:
i) a wash tub,
ii) a water inlet and waste water outlet in fluid communication with the wash tub,
iii) a fluid pathway extending from the waste water outlet to the water inlet,
iv) a pump for moving water along the fluid pathway,
v) a filter module comprising a plurality of semi-permeable membranes having an average pore size of 0.01 to 0.10 micron, and which is located within an inner chamber of a housing located along the fluid pathway, and wherein the volumetric ratio of the filter module to the cabinet is from 1:20 to 1:1000, and
vi) an aerator in fluid communication with the filter module.

12. The washing machine of claim 11 wherein the aerator is in fluid communication with the pump.

13. The washing machine of claim 11 wherein the aerator is in fluid communication with a blower.

14. A method for washing ware or laundry items using a washing machine comprising the following components which are housed within a cabinet:
i) a wash tub,
ii) a water inlet and waste water outlet in fluid communication with the wash tub,
iii) a fluid pathway extending from the waste water outlet to the water inlet,
iv) a pump for moving water along the fluid pathway,
v) a filter module comprising a plurality of semi-permeable membranes having an average pore size of 0.01 to 0.10 micron, and which is located within an inner chamber of a housing located along the fluid pathway, and wherein the volumetric ratio of the filter module to the cabinet is from 1:20 to 1:1000, and
vi) an aerator in fluid communication with the filter module;
wherein the method comprises a wash cycle including multiple stages wherein waste water resulting from a stage passes through the filter module and is reused.

15. The method of claim 14 wherein the filter module is aerated with gas bubbles.

16. The method of claim 14 wherein the wash cycle comprises at least one wash stage comprising the introduction of water and a detergent into the wash tub followed by at least one rinse stage wherein waste water which has passed through the filter module is introduced into the wash tub without adding detergent.
